(19) United States
(12) Patent Application Publication
(10) Pub. No.: US 2014/0195372 A1
(43) Pub. Date: Jul. 10, 2014

(54) SYSTEMS AND METHODS FOR LOCATING ONE OR MORE ITEMS IN A SHOPPING STORE

(71) Applicant: INTERNATIONAL BUSINESS MACHINES CORPORATION, Armonk, NY (US)

(72) Inventors: Richard T. Bassemir, Austin, TX (US); Eric Forestier, Perols (FR); Alfredo V. Mendoza, Georgetown, TX (US); Didier Petitprez, Saint Jean de Vedas (FR); Andrew G. Tonkin, Morrisville, NC (US)

(73) Assignee: INTERNATIONAL BUSINESS MACHINES CORPORATION, Armonk, NY (US)

(21) Appl. No.: 13/738,927

(22) Filed: Jan. 10, 2013

(51) Int. Cl. G06Q 30/06

(52) U.S. Cl. CPC G06Q 30/0639
USPC 705/26.8

(57) ABSTRACT

A system for intelligently locating one or more items in a shopping store with multiple items arranged in multiple aisles includes a first communication device having a shopping assistance application configured to allow a shopper to input a shopping list comprising one or more items. Also included are multiple second communication devices located in and associated with the plurality of aisles, with each second device being configured to detect the shopping list on the first device when the shopper is within a range of distance of the second device and transmit the detected list. The system may also include a backend server configured to receive detected list and sort the detected list dynamically based on an identified at least one item and the shopper. The backend server can also display the sorted list on the first device. The at least one item may be highlighted in the sorted list.

### FIELD OF THE INVENTION

The present disclosure relates to computerized systems for obtaining item information and more specifically to systems and methods to provide shopping assistance to shoppers.

### BACKGROUND

Typically, the shopping stores such as grocery stores provide multiple things of necessity to shoppers under one roof in a convenient manner. But consumers or shoppers often end up spending a lot of time in searching for a particular item as they might not be aware of its exact location in the shopping store. For example, for a grocery store, the shopper usually have a long list of items, and for locating the items the consumers might have to walk up and down a store aisle's. This may be tiring and challenging for the consumers or shoppers. In addition, shopping stores usually stock a large variety of items and different stores may stock different combination of items in each of their aisles. Therefore, shoppers may not be able to find every item of their shopping list on the first pass in the store and might have to backtrack to certain aisles.

Many shopping stores, grocery stores, or other large stores have developed systems to assist shoppers by providing a listing of products in the store alphabetically on signs suspended from the ceilings or printed listings on end of each aisle. Existing shopping list smartphone applications are mostly stand-alone applications that do not tell the shopper where a particular item is located within the store. A system is disclosed by Begum in a U.S. Pat. No. 6,177,880 for assisting shoppers while locating items in a shopping store. The U.S. Pat. No. 6,177,880 discloses an electronic display incorporated into a shopping cart handle that allows a shopper to locate items by category or brand names. However, this system only provides aisle numbers and is limited to about 50 item categories. These days usually the shopping stores stocks thousands of item categories. In addition, the Begum invention inquiries are limited to a scrolling mechanism, since it lacks a means for alphanumerical entries. Further, the Begum invention is applicable only to a grocery store type layout consisting of aisles. The system disclosed in Begum's patent is ineffective if there are no aisle numbers.

Therefore, the shopper does not have an efficient way of finding items from the shopping list because the shopper might have to depend on the signs posted on each numbered aisle. These signs only provide a general list of items in the aisle and can be missed as the shopper walks through the main aisle. This results in the shopper doubling back several times if he/she misses an item from one aisle, which is inefficient.

In light of above discussion and limitations of existing techniques, there exists a need for systems and methods for assisting shoppers in locating items in a shopping store in an effective manner.

### BRIEF SUMMARY

Embodiments of the present disclosure provide a system for intelligently locating one or more items in a shopping store. The shopping store includes a number of items arranged in a number of aisles. The system includes a first communication device including a shopping assistance application configured to allow a shopper to input a shopping list. The shopping list includes one or more items. The system also includes a number of second communication devices located in and associated with the aisles. Each second communication device is configured to detect the shopping list on the first communication device when the shopper is within a range of distance of the second communication device and transmit the detected list. The system includes a backend server configured to receive the detected list from at least one of the second communication devices. The backend server is further configured to check whether at least one item of the received list is present in an aisle associated with the second communication device from which the shopping list is received based on an identified location of the shopper. The backend server is also configured to dynamically sort the one or more items of the shopping list based on the check performed. The backend server is also configured to display the sorted list on the first communication device. The at least one item is highlighted and/or placed on top in the sorted list when the at least one item is present in the aisle which is closest to the shopper.

Another aspect of the present disclosure also provides a method for intelligently locating one or more items in a shopping store. The shopping store includes a number of items arranged in the aisles. The method includes detecting, by a second communication device associated with an aisle, a shopping list comprising the one or more items. A shopper inputs the shopping list on the first communication device through a shopping assistance application which is running on the first communication device. The method also includes transmitting, by the second communication device, the detected list to a backend server. The method further includes checking, by the backend server, whether at least one item of the received list is present in an aisle associated with the second communication device from which the shopping list is received based on an identified location of the shopper. The method also includes dynamically sorting, by the backend server, the one or more items in the shopping list based on the check performed. The method further includes displaying, by the backend server, the dynamically sorted list on the first communication device, wherein the at least one item is highlighted and/or placed on top in the sorted list when the at least one item is present in the aisle which is closest to the shopper.

Yet another embodiment of the present disclosure provides a computer program product embodied on a computer readable medium having instructions for intelligently locating an item in a shopping store. The shopping store includes a number of items arranged in a plurality of aisles. The computer program product performs the steps of detecting, by a second communication device associated with an aisle, a shopping list comprising the one or more items, the shopper inputs the shopping list on the first communication device through a shopping assistance application on the first communication device; transmitting, by the second communication device, the detected list to a backend server; checking, by the backend server, whether at least one item of the received list is present in an aisle associated with the second communication device from which the shopping list is received based on an identified location of the shopper; dynamically sorting, by the backend server, the one or more items in the shopping list based on the check performed; and displaying, by the backend server, the dynamically sorted list on the first communication device, wherein the at least one item is highlighted and/or placed on top in the sorted list when the at least one item is present in the aisle which is closest to the shopper.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates an exemplary environment where various embodiments of the present disclosure may function;

FIG. 2 illustrates an exemplary first communication device i.e. a smart phone including a shopping assistance application, in accordance with an embodiment of the present disclosure;

FIG. 3 is an exemplary environment showing the location of the one or more second communication devices, in accordance with an embodiment of the present disclosure;

FIG. 4 illustrates exemplary structural components of the backend server 108, in accordance with an embodiment of the present disclosure;

FIG. 5 illustrates communication between one or more devices in the shopping store, in accordance with an embodiment of the present disclosure;

FIG. 6 depicts before and after display of one or more items on the first communication device after the communication between the backend server and the shopping assistance application happens, in accordance with an embodiment of the present disclosure; and

FIG. 7 is a flowchart diagram illustrating a method for intelligently locating one or more items in a shopping store, in accordance with an embodiment of the present disclosure.

### DETAILED DESCRIPTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired, optical fiber cable, RF cable, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the shopper's computer, partly on the shopper's computer, as a stand-alone software package, partly on the shopper's computer and partly on a remote computer or entirely on the remote computer or server. In the latter scenario, the remote computer may be connected to the shopper's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

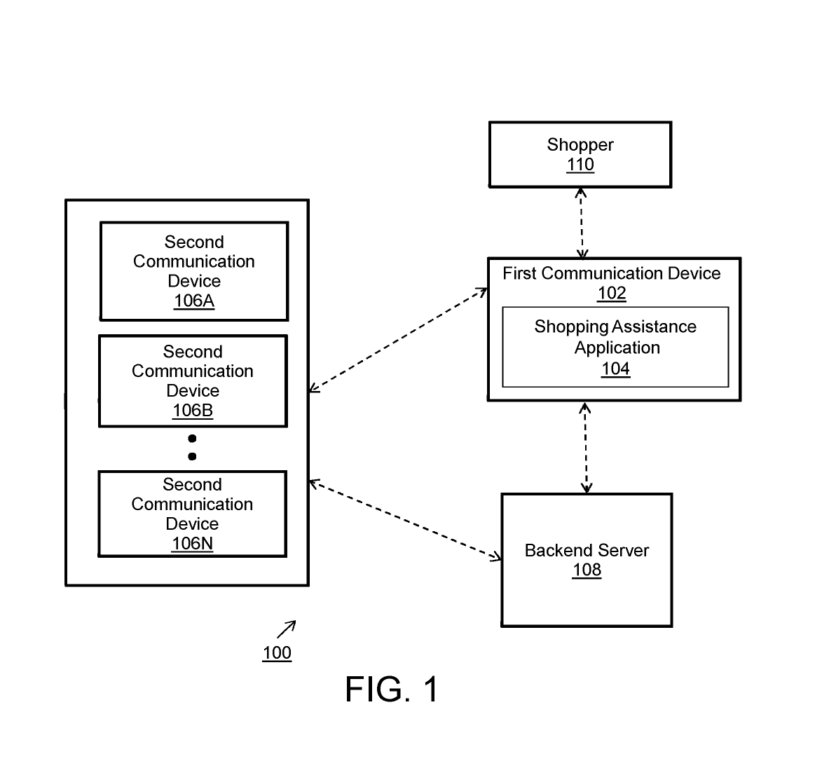

With reference now to the figures and in particular with reference to FIG. 1, exemplary diagram of an exemplary shopping assistance system is provided in which illustrative embodiments may be implemented. It should be appreciated that FIG. 1 is only exemplary and are not intended to assert or imply any limitation with regard to the environment in which different embodiments may be implemented. Many modifications to the depicted environment may be made.

FIG. 1 illustrates an exemplary environment 100 where various embodiments of the present disclosure may function. The environment 100 may include a shopping assistance application 104 running on a first communication device 102. The first communication device 102 can be any portable communication device capable of communicating with other nearby communication devices. Examples of the first communication device may include, but not limited to, a mobile phone, a smartphone, a personal digital assistant (PDA), a tablet computer, a laptop, and so forth. The shopping assistance application 104 allows a shopper 110 to enter a list of one or more items on the first communication device 102. The items can be commodities or products available in a shopping store. Further, the shopper 110 can be any person who enters the shopping store. The shopper 110 may carry the first communication device 102 to the shopping store. Further, the environment 100 can be a shopping store. The shopping assistance application 104 can be hardware, software, firmware, or combination of these. Further, the shopping assistance application 104 is configured to allow the shopper 110 to input a number of shopping lists associated with multiple different stores. The stores can be electronics store, grocery store, medical store, and so forth.

The environment 100 may further include a number of second communication devices 106A-N located or placed strategically in the shopping store (or the environment 300). The shopping store may include a number of products or items placed in a number of shelves in a number of aisles. The second communication devices 106A-N can be any suitable communication devices capable of communicating with the first communication device 102 and/or a backend server 108 via one or more wireless communication technologies or protocols such as, but not limited to, Bluetooth, WAN 802.11, and so forth. Further, each of the second communication devices 106A-N is configured to detect the shopping list on the first communication device 102 when the shopper 110 is within a range of distance of the second communication device 106. Each of the second communication devices 106A-N is further configured to transmit the detected list to the backend server 108.

The backend server 108 may be an internal server located within the premises of the shopping store. In an embodiment, the backend server 108 may be located remotely and may connect and communicate with the second communication devices 106A-N and the first communication device 102 through a network (not shown) such as, but not limited to, the Internet. The backend server 108 is configured to receive the detected list from at least one of the second communication devices 106A-N. The backend server 108 is also configured to check whether at least one item of the received list is present in an aisle associated with the second communication device (e.g. 106) from which the list is received based on an identified location of the shopper 110. For example, if the shopper 110 is near aisle 5A then the second communication device associated with aisle 5A may send the list to the backend server 108. The backend server 108 is further configured to dynamically sort the one or more items of the received list based on the check performed. The items in the list closest to the person is sorted starting from the closest item to the furthest. In other words the closest item the person is interested in “bubbles up” the list so that it is the first item on the list. The one or more items in the shopping list are dynamically sorted based on the identified location of the one or more items in the plurality of aisles with respect to the identified location of the shopper 110 in the shopping store. In an embodiment of the present disclosure, the closest item is highlighted and placed on the top in the sorted list. The backend server 108 is further configured to display the sorted list on the first communication device 102. The at least one item may be highlighted using a specific color and/or may be placed on top in the sorted list when the at least one item is present in the aisle which is closest to the shopper 110. The backend server 108 is further configured to identify a current location of the shopper 110 in the shopping store. The backend server 108 may also re-sort the one or more items of the sorted list dynamically based on a current location of the shopper 110 in the shopping store. The location of the shopper 110 may change in the shopping store as the shopper 110 keeps on moving. The backend server 108 is configured to identify the location of the shopper 110.

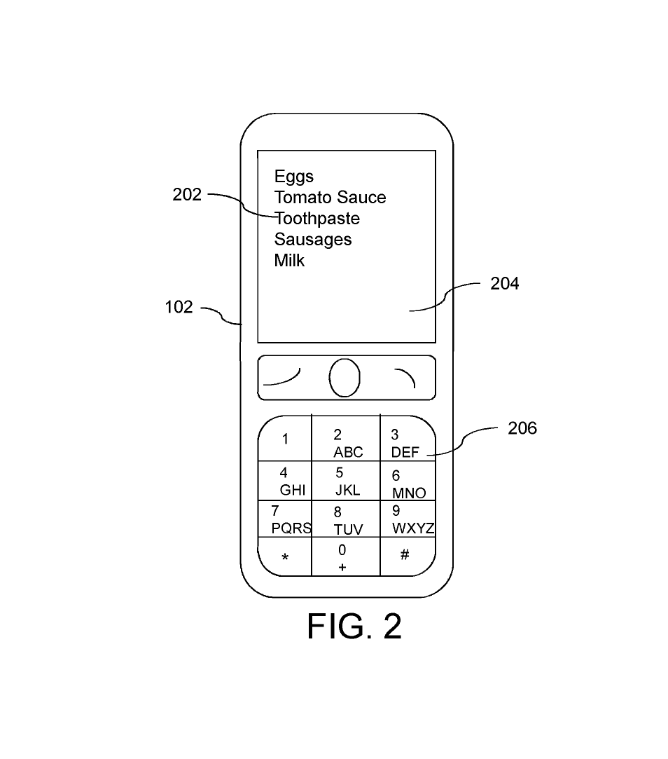

FIG. 2 illustrates an exemplary first communication device i.e. a smart phone including a shopping assistance application, in accordance with an embodiment of the present disclosure. The smart phone 102 or the first communication device 102 may include a display screen 202 configured to display one or more characters entered by the shopper 110. As discussed with reference to FIG. 1, the shopper 110 may enter a shopping list 204 including one or more items. For example, the items may be milk, tomato sauce, toothpaste, sausages, eggs, and so forth. The first communication device 102 further includes one or more buttons or keys 206 to allow the shopper 110 to enter the list of items. Though not shown, the first communication device 102 also includes the shopping assistance application 104 configured to communicate with the second communication devices 106A-N and the backend server 108.

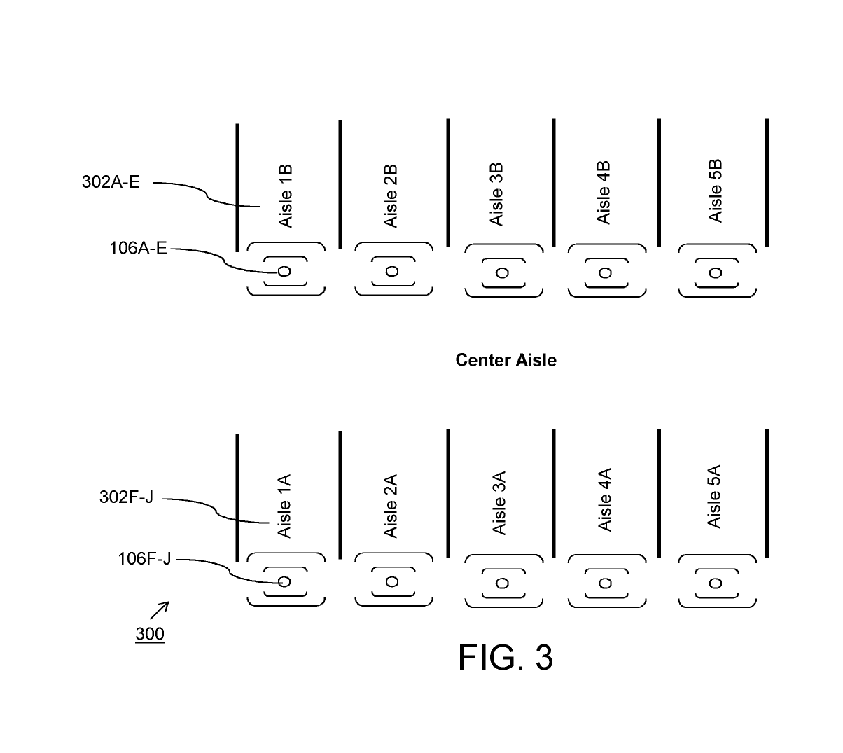

FIG. 3 is an exemplary environment 300 showing the location of the one or more second communication devices 106A-N, in accordance with an embodiment of the present disclosure. As shown, the environment 300 may include one or more aisles 302A-G, each of these aisles has an associated unique identification (e.g. 1A-5A and 1B-5B). A person skilled in the art will appreciate that the environment 300 may include more aisles 302 than shown. Each of the aisles 302 may include a number of items or products placed in one or more shelves (not shown). At least one second communication device 106 is placed strategically near each of the aisles 302. When the first communication device 102 is within a predefined range of distance of the second communication device then the second communication device 106 may detect a shopping list on the first communication device 102. The predefined range may define a distance in which the second communication device 106 may detect another communication device such as, the first communication device 102. The second communication device 106 may have the predefined range of 2 meters, 1 meter, 3 meters, and so forth. Further, the second communication device 106 is configured to establish a two-way communication with the shopping assistance application 104 running on the first communication device 102. The communication distance is such that only the second communication device 106, which is nearest to the shopper 110, is able to connect with the first communication device. So, if the person is near or at Aisle 5A, only the second communication device 106J present on the Aisle 5A is able to “talk” or communicate with the first communication device 102. In essence the backend server 108 knows that the communication is coming from Aisle 5A.

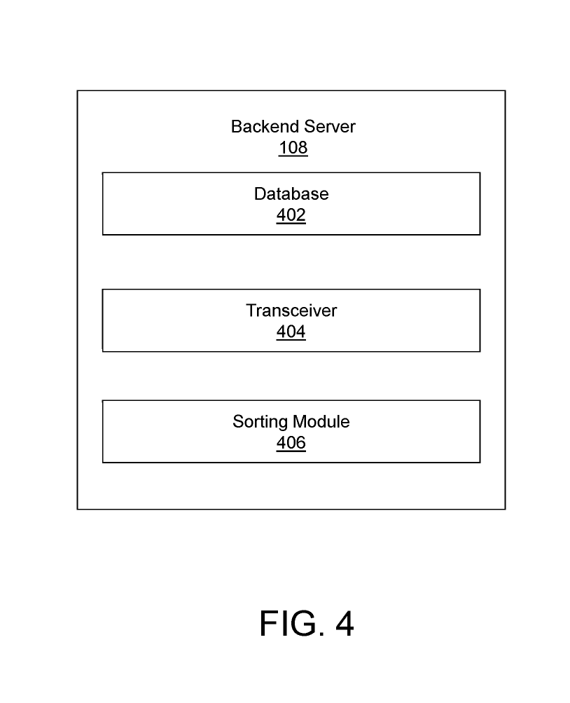

FIG. 4 illustrates exemplary structural components of the backend server 108, in accordance with an embodiment of the present disclosure. The backend server includes a database 402 configured to store details about a number of items present in a shopping store. The items can be such as, but not limited to, grocery items, medical items, household items, depending on the type of the shopping store. In an embodiment of the present disclosure, the database 402 is configured to store one or more shopping lists associated with the one or more shoppers (e.g. shopper 110). The backend server 108 further includes a transceiver 404 configured to receive one or more shopping lists and other information such as unique ID of the second communication devices 106A-N from the one or more second communication devices 106A-N. The transceiver 404 is also configured to transmit or send sorted lists to the first communication device(s) 110 for display. The backend server 108 also includes a sorting module 406 configured to identify location of the shopper(s) 110, the first communication device 102 and the second communication devices 106A-N. The sorting module 406 is also configured to check whether at least one item of the received list is present in an aisle 302A-N associated with the second communication devices 106A-N from which the shopping list is received based on an identified location of the shopper 110. The sorting module 406 is further configured to dynamically sort or re-sort the one or more items of the shopping list based on the check performed and current location of the shopper 110.

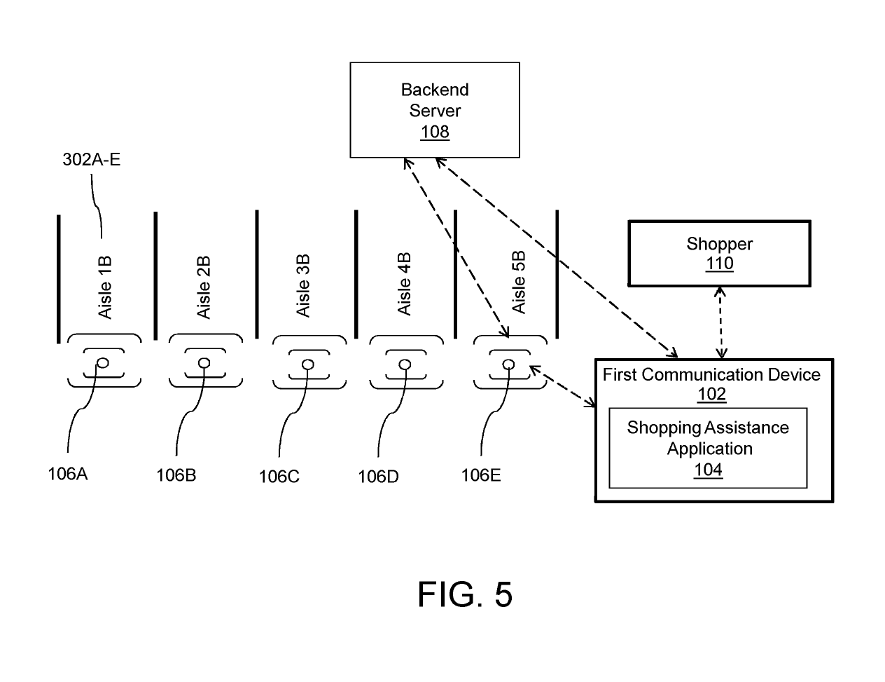

FIG. 5 illustrates communication between one or more devices in the shopping store, in accordance with an embodiment of the present disclosure. As discussed with reference to FIGS. 1-4, the shopper 110 may input a shopping list including one or more items using the shopping assistance application 104 on the first communication device 102. The shopper 110 may enter the shopping store by carrying the first communication device 102. As soon the shopper 110 (or the first communication device 102) comes in a range of one of the second communication devices 106A-N, the second communication device such as 106E detects the shopping list. Then, the second communication device 106E sends the detected list to the backend server 108, which may be located inside or outside of the shopping store premises. The messages received from the first communication device 102 is sent to the backend server 108 by the second communication device 106, processed and then responded to. The response message is received by the first communication device 102 and then acted on. The backend server 108 processes and sorts out the list according to where the shopper 110 is currently located in the store. Upon receiving information from Aisle 5A together with the list of items from the shopping assistance application 104, the backend server 108 can process the list and figure out if there is an item on that specific Aisle 5A that is on the list.

The backend server 108 may receive, analyze and process the shopping list. The backend server 108 may check whether at least one item of the received shopping list is present in the aisle 5B, which is associated with the second communication device 106E based on an identified location of the shopper. Thereafter, the backend server 108 dynamically sorts the one or more items of the shopping list based on the check performed. If for example an item on the list is milk, and milk is in Aisle 5A, then the list sent back to the first communication device sorts out milk to be on top of the list.

Then, the backend server 108 may send and display the sorted list on a display associated with the first communication device 102. Further, in the sorted list the at least one item is highlighted and/or placed on the top in the sorted list when the at least one item is present in the aisle 5B, which is closest to the shopper. Thereafter, the shopper 110 may pick the at least one item from the location identified through the displayed sorted list.

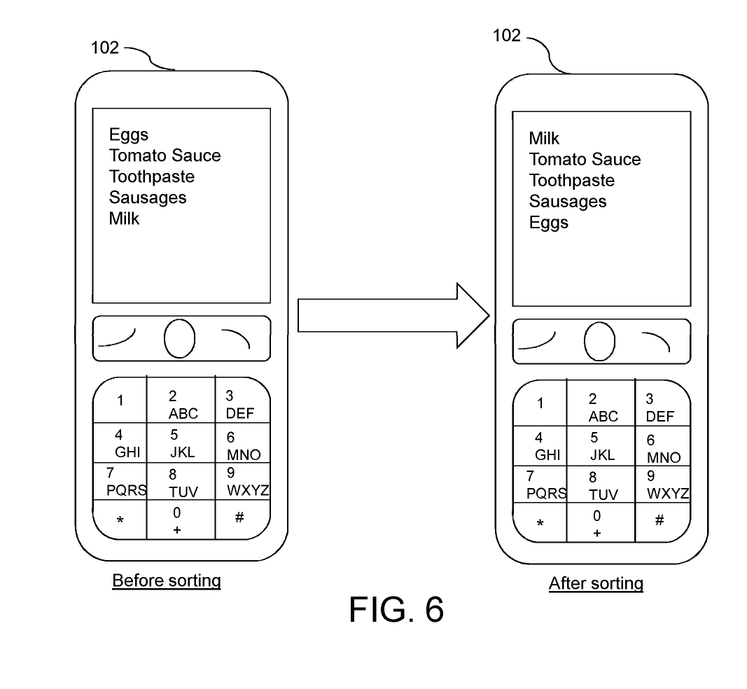

FIG. 6 depicts before and after display of one or more items on the first communication device 102 after the communication between the backend server 108 and the shopping assistance application 104 happens, in accordance with an embodiment of the present disclosure. As shown, the at least one product i.e. milk in this example, is placed on the top when the milk is located in the aisle near to the shopper 110. The at least one product may also be highlighted using a color, such as red, blue, green, and so forth. As the shopper 110 moves in the shopping store, the shopping list may get resorted and display on the first communication device 102 may change. Further, after picking the item from a shelf in the aisle the shopper 110 may touch the highlighted item to disable it. In an embodiment, the highlighted item goes at the bottom or is removed from the sorted list after receiving the selection information from the shopper 110, i.e. when the shopper 110 has touched the at least one item.

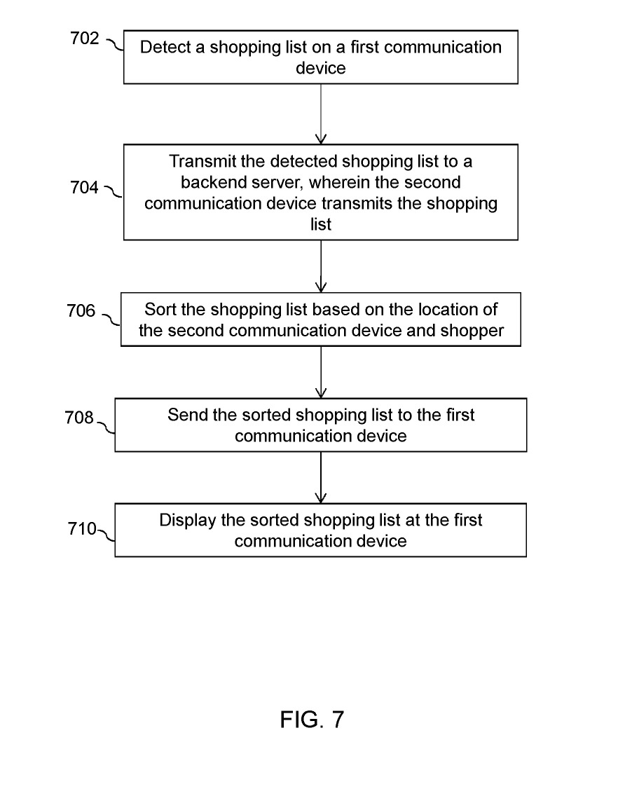

FIG. 7 is a flowchart diagram illustrating a method for intelligently locating one or more items in a shopping store, in accordance with an embodiment of the present disclosure. As discussed with reference to FIGS. 1-4, the shopping store includes a number of second communication devices 106A-N placed strategically near each aisle 302A-E in the store. Further, the shopping store has an associated backend server 108 which may or may not be present inside the shopping store. The second communication devices 106A-N may communicate with the backend server 108 and the first communication device 102.

At step 702, one of the second communication devices 106A-N detects a shopping list including one or more items or product details on the first communication device 102. The shopper 110 enters the shopping list on the first communication device 102 using the shopping assistance application 104. At step 704, the shopping list may be transmitted to the backend server 108 by the second communication device such as 106A. Then at step 706, the backend server analyzes and dynamically sorts the shopping list based on an identified location of the user and the aisle associated with the second communication device 106A. In an embodiment, the sorting module 406 sorts the received shopping list. At step 708, the backend server 108 may send the sorted list to the first communication device 102. Thereafter, at step 710, the sorted list is displayed on the first communication device 102. In an embodiment of the present disclosure, the backend server 108 may display the sorted list on a display associated with the first communication device 102. In another embodiment, the shopping assistance application running on the first communication device 102 may display the sorted list at the first communication device 102.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general-purpose computers, special purpose computers, or other programmable data processing translator to produce machines, such that the instructions, which execute on the computers or other programmable data processing translator create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims. The invention has been described in the general context of computing devices, phone and computer-executable instructions, such as program modules, being executed by a computer. Generally, program modules include routines, programs, characters, components, data structures, etc., that perform particular tasks or implement particular abstract data types. A person skilled in the art will appreciate that the invention may be practiced with other computer system configurations, including hand-held devices, multiprocessor systems, microprocessor-based or programmable consumer electronics, network PCs, minicomputers, mainframe computers, and the like. Further, the invention may also be practiced in distributed computing worlds where tasks are performed by remote processing devices that are linked through a communications network. In a distributed computing world, program modules may be located in both local and remote memory storage devices.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the various embodiments of the present invention has been presented for purposes of illustration, but is not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for intelligently locating one or more items in a shopping store, wherein the shopping store comprises a plurality of items arranged in a plurality of aisles, the system comprising:
a first communication device comprising a shopping assistance application configured to allow a shopper to input a shopping list comprising the one or more items;
a plurality of second communication devices located in and associated with the plurality of aisles, wherein each second communication device is configured to:
detect the shopping list on the first communication device when the shopper is within a range of distance of the second communication device; and
transmit the detected list; and
a backend server configured to:
receive the detected list from at least one of the plurality of second communication devices;
check whether at least one item of the received list is present in an aisle associated with the second communication device from which the shopping list is received based on an identified location of the shopper;
dynamically sort the one or more items of the shopping list based on the check performed; and
display the sorted list on the first communication device, wherein the at least one item is at least one of highlighted or placed on top in the sorted list when the at least one item is present in the aisle which is closest to the shopper.

2. The system of claim 1, wherein the shopping assistance application is further configured to communicate with the plurality of second communication devices and the backend server.

3. The system of claim 1, wherein the first communication device comprises a smart phone.

4. The system of claim 1, wherein the backend server comprises a database configured to shopping store details about the plurality of items present in the shopping store.

5. The system of claim 4, wherein the shopping list includes one or more items of the plurality of items stored in the database.

6. The system of claim 5, wherein the shopping assistance application is further configured to allow the shopper to input a plurality of shopping lists associated with a plurality of shopping stores.

7. The system of claim 6, wherein the one or more items in the shopping list are dynamically sorted based on the identified location of the one or more items in the plurality of aisles with respect to the identified location of the shopper in the shopping store, further wherein the closest item is highlighted and placed on the top in the sorted list.

8. The system of the claim 7, wherein shopping assistance application is configured to allow the shopper to disable the at least one highlighted item by selecting the at least one highlighted item after picking the item from its respective location in the aisle.

9. The system of claim 8, wherein the backend server is configured to:
identifying a current location of the shopper in the shopping store; and
re-sort the one or more items of the sorted list dynamically based on a current location of the shopper in the shopping store, wherein the location of the shopper changes in the shopping store as the shopper moves.

10. The system of claim 9, wherein the backend server is located within the premises of the shopping store.

11. The system of claim 10, wherein the backend server is located remotely from the shopping store.

12. A method for intelligently locating one or more items in a shopping store, wherein the shopping store comprises a plurality of items arranged in a plurality of aisles, the method comprising:
detecting, by a second communication device associated with an aisle, a shopping list comprising the one or more items, wherein a shopper inputs the shopping list on the first communication device through a shopping assistance application on the first communication device;
transmitting, by the second communication device, the detected list to a backend server;
checking, by the backend server, whether at least one item of the received list is present in an aisle associated with the second communication device from which the shopping list is received based on an identified location of the shopper;
dynamically sorting, by the backend server, the one or more items in the shopping list based on the check performed; and
displaying, by the backend server, the dynamically sorted list on the first communication device, wherein the at least one item is at least one of highlighted or placed on top in the sorted list when the at least one item is present in the aisle which is closest to the shopper.

13. The method of claim 12, wherein the shopping assistance application is configured to communicate with the plurality of second communication devices and the backend server.

14. The method of claim 12, wherein the first communication device comprises a smartphone.

15. The method of claim 12, wherein the backend server further comprises a database configured to store details about the plurality of items present in the shopping store.

16. The method of claim 15, wherein the shopping list includes one or more items of the plurality of items stored in the database.

17. The method of claim 12 further comprising allowing, by the shopping assistance application, the shopper to input a plurality of lists associated with a plurality of shopping stores on the first communication device.

18. The method of claim 12, wherein the one or more items in the list are dynamically sorted based on the identified location of the one or more items in the plurality of aisles with respect to the identified location of the shopper in the shopping store, further wherein the closest item is highlighted and placed on the top in the sorted list.

19. The method of claim 12 further comprising allowing, by the shopping assistance application, the shopper to disable the at least one highlighted item by selecting the at least one highlighted item after picking the item from its respective location in the aisle.

20. The method of claim 12 further comprising:
identifying, by the backend server, a current location of the shopper in the store; and
re-sorting, by the backend server, the one or more items of the sorted list dynamically based on a current location of the shopper in the store, wherein the shopper is moving in the store.

21. The method of claim 20, wherein the backend server is located within the premises of the shopping store.

22. The method of claim 21, wherein the backend server is located remotely from the shopping store.

23. A computer program product embodied on a computer readable medium having instructions for intelligently locating an item in a shopping store, wherein the shopping store comprises a plurality of items arranged in a plurality of aisles, the computer program product performing the steps of:
detecting, by a second communication device associated with an aisle, a shopping list comprising the one or more items, wherein a shopper inputs the shopping list on the first communication device through a shopping assistance application on the first communication device;
transmitting, by the second communication device, the detected list to a backend server; checking, by the backend server, whether at least one item of the received list is present in an aisle associated with the second communication device from which the shopping list is received based on an identified location of the shopper;
dynamically sorting, by the backend server, the one or more items in the shopping list based on the check performed; and
displaying, by the backend server, the dynamically sorted list on the first communication device, wherein the at least one item is at least one of highlighted or placed on top in the sorted list when the at least one item is present in the aisle which is closest to the shopper.

24. The computer program product of claim 23 further comprising instructions for allowing the shopper to input a plurality of lists associated with a plurality of shopping stores on the first communication device.

25. The computer program product of claim 24 further comprising instructions for allowing the shopper to disable the at least one highlighted item by selecting the at least one highlighted item after picking the item from its respective location in the aisle.
